(19) United States
(12) Patent Application Publication
(10) Pub. No.: US 2021/0206337 A1
(43) Pub. Date: Jul. 8, 2021

(54) Seatbelt Indicator Clip

(71) Applicant: Jayson J. Rivera, Tulalip, WA (US)

(72) Inventor: Jayson J. Rivera, Tulalip, WA (US)

(21) Appl. No.: 17/076,962

(22) Filed: Oct. 22, 2020

Related U.S. Application Data
(60) Provisional application No. 62/958,415, filed on Jan. 8, 2020.

(51) Int. Cl. B60R 22/18; B60R 22/48; A44B 11/00

(52) U.S. Cl. CPC B60R 22/18; B60R 22/48; B60R 2022/4816; B60R 2022/1806; A44B 11/006

(57) ABSTRACT

A seatbelt indicator clip is shown and described. The seatbelt indicator clip includes a planar body. The planar body has a protrusion extending from one side. The protrusion is a seatbelt male connector. The seatbelt male connector is sized to be received by a seatbelt female connector. The planar body has an attachment device secured thereto. The attachment device will allow the seatbelt indicator clip to be secured to a device when in storage.

### CROSS REFERENCE TO RELATED APPLICATIONS

This application claims the benefit of U.S. Provisional Application No. 62/958,415 filed on Jan. 8, 2020. The above identified patent application is herein incorporated by reference in its entirety to provide continuity of disclosure.

### BACKGROUND OF THE INVENTION

The present invention relates to seatbelts and seatbelt alarms. More particularly, the present invention provides a buckle to stop the seat belt alarm from ringing.

Modern vehicles are equipped with seatbelt alarm systems. The seatbelt alarms are mostly weight activated. This means that when a person places an item on their seat the alarm may be triggered. This could cause annoyance for a vehicle operator. Further, in some instances, pets ride on seats. Pets may set off the seat belt indicator. This can be complicated to prevent, as a pet may only set of the alarm in certain positions.

In other aspects seat belt alarms may be turned off to prevent the above-mentioned items. However, this is usually an extremely difficult process. Further, a person may only want to turn the alarm off temporarily. This could mean that individuals could have to deal with the beeping of the alarm in some instances.

Consequently, there is a need for an improvement in the art of seatbelt alarms. The present invention substantially diverges in design elements from the known art while at the same time solves a problem many people face when placing items on a car seat and the seatbelt alarm is triggered. In this regard the present invention substantially fulfills these needs.

### SUMMARY OF THE INVENTION

The present invention provides a seatbelt indicator clip wherein the same can be utilized for providing convenience for the user when using a seatbelt indicator clip. The seatbelt indicator clip is comprised of a seatbelt male connector, wherein the connector is sized to be received by a female seatbelt connector. An attachment device is secured to the planar body.

Another object of the seatbelt indicator clip is to provide a device with a planar body. The planar body has a protrusion which is the seatbelt male connector.

Another object of the seatbelt indicator clip is to provide an attachment device which is secured to the planar body.

Another object of the seatbelt indicator clip is to provide an attachment device that is a tension loaded securement clip.

Another object of the seatbelt indicator clip is to provide an attachment device which is a magnet.

Another object of the seatbelt indicator clip is to provide an attachment device which is a tension loaded securement clip with a magnet attached to one side of the tension loaded securement clip.

Another object of the seatbelt indicator clip is to provide at least one aperture located through the planar body.

Another object of the seatbelt indicator clip is to provide a planar body which is made from metal.

Another object of the seatbelt indicator clip is to provide a planar body which is made from plastic.

Other objects, features and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the seatbelt indicator clip.

FIG. 2 shows a top down view of an embodiment of the seatbelt indicator clip.

FIG. 3 shows an exploded view of an embodiment of the seatbelt indicator clip.

FIG. 4 shows a perspective in-use view of an embodiment of the seatbelt indicator clip.

### LIST OF REFERENCE NUMERALS

With regard to the reference numerals used, the following numbering is used throughout the drawings.
101 Planar body
102 Protrusion
103 Aperture
104 Attachment device
201 Magnet
202 Apertures
301 Top side of attachment device
302 Bottom side of attachment device
303 Securement pin
304 Spring
401 Bungie cords

### DETAILED DESCRIPTION OF THE INVENTION

Reference is made herein to the attached drawings. Like reference numerals are used throughout the drawings to depict like or similar elements of the seatbelt indicator clip. For the purposes of presenting a brief and clear description of the present invention, a preferred embodiment will be discussed as used for the seatbelt indicator clip. The figures are intended for representative purposes only and should not be considered to be limiting in any respect.

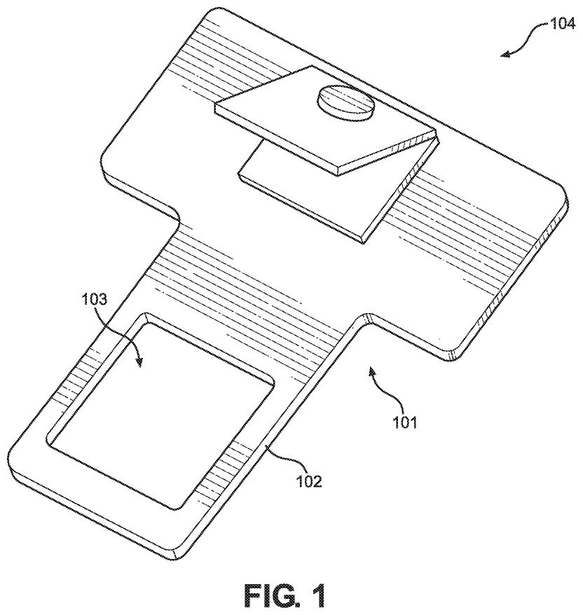

Referring now to FIG. 1, there is shown a perspective view of an embodiment of the seatbelt indicator clip. The seatbelt indicator clip includes a planar body 101. In one embodiment, the planar body 101 has a rectangular cross-section. In another embodiment, the planar body 101 has a circular cross-section. In one embodiment, the planar body 101 is made from plastic. This will allow for the item to be easily mass produced. In another embodiment, the planar body 101 is made from metal. This will ensure that the device is wear resistant and is not easily bent and or broken. While examples of materials are listed within this application one of ordinary skill in the art will understand that this device may be made out of a large variety of different materials.

In some embodiments, the planar body 101 has a protrusion 102 extending from a side of the planar body 101. This protrusion 102 is proportioned to fit within the female connector of a seatbelt. In another embodiment, the planar body 101 is proportioned to fit within the female connector of a seatbelt. The protrusion 102 has an aperture 103 located therein. This will allow the protrusion 102 to function as the male connector for a seatbelt. This will allow the protrusion 102, or the planar body 101 in some embodiments to secure to a seatbelt connector. In one embodiment the protrusion 102 will have a universal fit. This means that the protrusion 102 is proportioned to fit within and secure to any vehicle seatbelt connection.

The planar body 101, has an attachment device 104 located thereon. In the shown embodiment, the attachment device 104 is a tension loaded securement clip. The attachment device 104 will allow the seatbelt indicator clip to be secured to various elements of a vehicle for storage. In other embodiments, other attachment devices 104 may be used. A tension loaded securement clip will allow for the seatbelt indicator clip to be easily stored and removed.

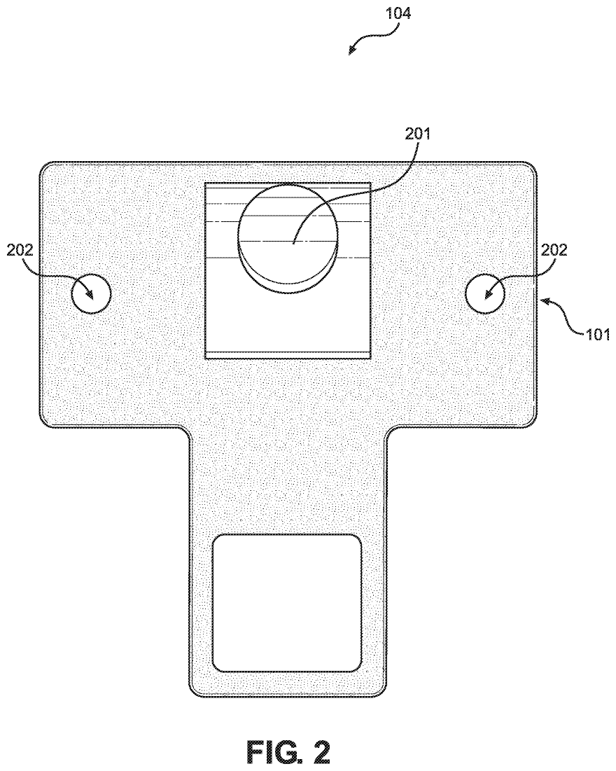

Referring now to FIG. 2, there is shown a top down view of an embodiment of the seatbelt indicator clip. In the shown embodiment, the attachment device 104 has a magnet 201 located thereon. The magnet 201 will allow the seatbelt indicator clip to be secured to additional items within a vehicle. In another embodiment, the magnet 201 is used as the sole attachment device 104. In different embodiments the magnet 201 is of different strengths. In one embodiment a magnet 201 of a high strength is used. This will ensure the device has a safe connection when being stored.

In one embodiment, the planar body 101 includes a plurality of apertures 202. The in the shown embodiment, the plurality of apertures 202 are located near the perimeter of the planar body 101. The plurality of apertures 202 will allow for items such as cords to be secured to the planar body 101.

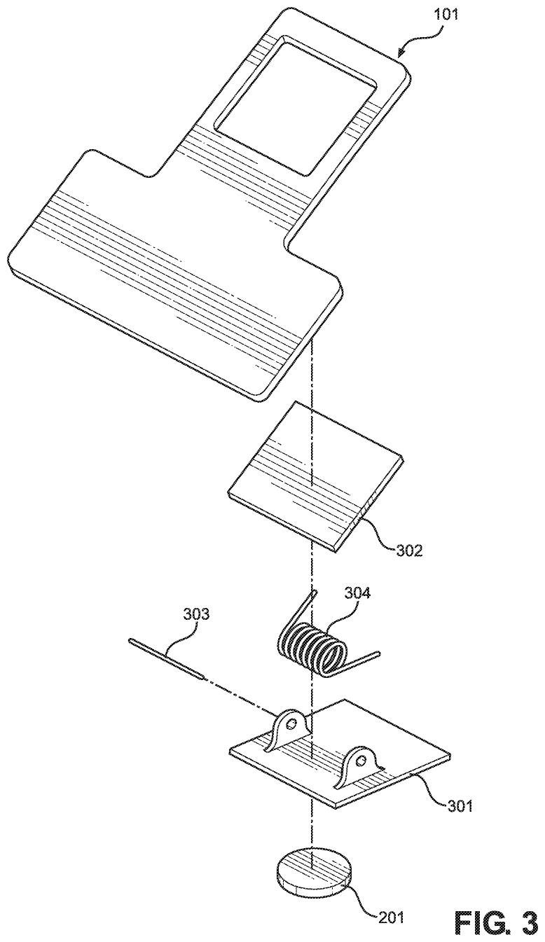

Referring now to FIG. 3, there is shown an exploded view of an embodiment of the seatbelt indicator clip. In this embodiment, the shown seatbelt indicator clip has a tension loaded securement clip with a magnet 201 as the attachment device. The tension loaded securement clip is comprised of several parts. There is a top side 301 and a bottom side 302. The top and bottom sides 301, 302 will be hingedly secured together via a securement pin 303. A spring 304 will be located between the top side 301 and the bottom side 302. The spring 304 will bias the clip in a closed position. In some instances, the spring 304 is over biased in order to ensure a secured connection that will not accidentally release the seatbelt indicator clip when stored.

In one embodiment, the attachment device is secured to the planar body 101 with a weld. This will ensure a firm permanent securement. In another embodiment, the attachment device is secured to the planar body 101 with at least one fastener. This will allow the attachment device to be replaced if needed. In one embodiment, the magnet 201 is secured to the attachment device using a fastener.

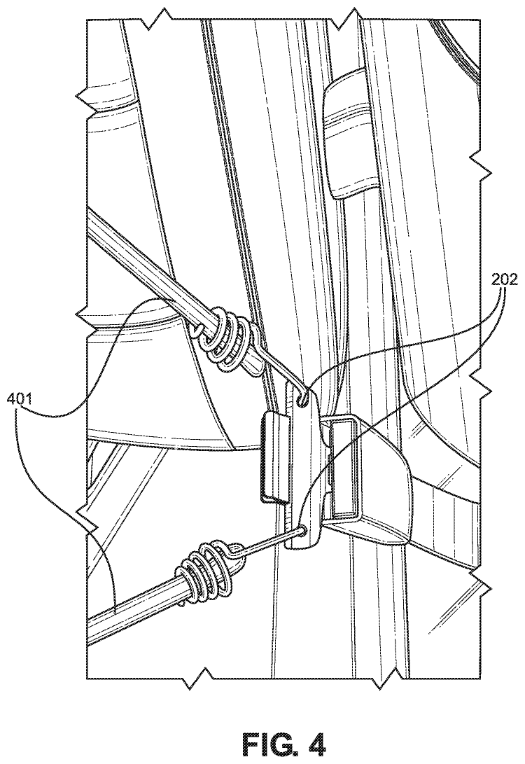

Referring now to FIG. 4, there is shown a perspective in-use view of an embodiment of the seatbelt indicator clip. In use, the seatbelt indicator clip is removed from a storage place within a vehicle. The protrusion of the device is then placed within the female connector of a seatbelt. This will allow for an individual to place a heavy item on the seat of a vehicle without the seatbelt indicator constantly causing an alarm within the vehicle.

In the shown embodiment the apertures 202 have bungie cords 401 secured therein. The bungie cords 401 will allow an individual to secure the item that is located within the seat to the seat. This will allow a user to more easily secure an item for transport. This is because cords can then be easily adjustable in a manner not allowable by a traditional seat belt. Further, this will prevent the seatbelt alarm from constantly ringing.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A seatbelt indicator clip, the clip comprising:
a seatbelt male connector, wherein the connector is sized to be received by a female seatbelt connector;
an attachment device secured to the male connector.

2) The seatbelt indicator clip of claim 1, further comprising a planar body, wherein the body has a protrusion which is the seatbelt male connector.

3) The seatbelt indicator clip of claim 2, wherein the attachment device is secured to the planar body.

4) The seatbelt indicator clip of claim 1, wherein the attachment device is a tension loaded securement clip.

5) The seatbelt indicator clip of claim 1, wherein the attachment device is a magnet.

6) The seatbelt indicator clip of claim 1, wherein the attachment device is a tension loaded securement clip with a magnet attached to one side of the tension loaded securement clip.

7) The seatbelt indicator clip of claim 2, further comprising at least one additional aperture located through the planar body.

8) The seatbelt indicator clip of claim 2, wherein the planar body is made from metal.

9) The seatbelt indicator clip of claim 2, wherein the planar body is made from plastic.

10) A seatbelt indicator clip, the clip consisting of:
a planar body, wherein the planar body has a protrusion extending from one side;
wherein the protrusion is a seatbelt male connector, wherein the seatbelt male connector is sized to be received by a seatbelt female connector;
the planar body has an attachment device secured thereto, wherein the attachment device is a tension loaded securement clip having a magnet attached thereto.

11) The seatbelt indicator clip of claim 10, wherein the attachment device is secured to the planar body.

12) The seatbelt indicator clip of claim 10, further comprising at least one aperture located through the planar body.

13) The seatbelt indicator clip of claim 10, wherein the planar body is made from metal.

14) The seatbelt indicator clip of claim 10, wherein the planar body is made from plastic.
